(19) United States
(12) Patent Application Publication
(10) Pub. No.: US 2015/0001929 A1
(43) Pub. Date: Jan. 1, 2015

(54) POWER TRANSFORMATION SYSTEM

(71) Applicant: Honeywell International Inc., Morristown, NJ (US)

(72) Inventors: Robert D. Juntunen, Minnetonka, MN (US); Devin Diedrich, Ramsey, MN (US); Milan Krkoska, Brno (CZ)

(21) Appl. No.: 14/300,228

(22) Filed: Jun. 9, 2014

Related U.S. Application Data
(60) Provisional application No. 61/841,191, filed on Jun. 28, 2013.

(51) Int. Cl. H02M 7/04; H02J 3/00

(52) U.S. Cl. CPC H02M 7/04; H02J 3/00
USPC 307/23; 307/52; 307/24

(57) ABSTRACT

A power transformation system for powering a device indirectly through an electrical load connected to a power source. The transfer of energy from the power source via the load may go undetected. The system may store energy from the load in an ultra or super capacitor. This energy may be used to power Wi-Fi and various thermostat applications, among other things, associated with HVAC and building automation and management systems. Energy from the load may be supplemented or substituted with energy from a battery and/or a buck converter.

This application claims the benefit of U.S. Provisional Application No. 61/841,191, filed Jun. 28, 2013. U.S. Provisional Application No. 61/841,191, filed Jun. 28, 2013, is hereby incorporated by reference.

### BACKGROUND

The present disclosure pertains to power supplies for devices and particularly to taking power from the supplies for other devices. The disclosure also pertains to storage of power taken from the power supplies.

### SUMMARY

The disclosure reveals a power transformation system for powering a device indirectly through an electrical load connected to a power source. The transfer of energy from the power source via the load may go undetected. The system may store energy from the load in an ultra or super capacitor. This energy may be used to power Wi-Fi and various thermostat applications, among other things, associated with HVAC and building automation and management systems. Energy from the load may be supplemented or substituted with energy from a battery and/or a buck converter.

### BRIEF DESCRIPTION OF THE DRAWING

FIG. 1a is a diagram of a power transformation circuit;

FIG. 1b is a diagram of another version of the power transformation circuit;

FIG. 1c is a diagram of the power transformation circuit having a different connection from a buck converter to an output circuit;

FIG. 1d is a diagram of example loads connected to outputs of the power transformation circuit;

FIG. 2 is a diagram of a waveform indicating an inductive load;

FIG. 3 is a diagram of a waveform indicating a resistive load;

FIGS. 4 and 5 are schematic diagrams of current sources;

FIGS. 6a, 6b and 6c are diagrams of waveforms of various aspects of the power transformation circuit; and

FIGS. 7a, 7b, 7c, 7d, 7e, 7f and 7g are diagrams of activities of certain portions of the power transformation circuits in FIGS. 1a-1c; and

FIGS. 8a, 8b, 9a-9c, 10a-10c, 11a-11c and 12a-12c are schematics of an illustrative example of the present power transformation circuit.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

A powering of devices not connected directly to a power source return except through electrical loads may be regarded as a power transformation (PT) system. The present power transformation system may have advantages over systems having ordinary or related-art power techniques. For instance, the system may have a particular use in thermostat applications over relatively large dynamic load currents ranging from 100 uA to 1 A with a low AC voltage applied. Thermostats utilizing power obtained in the present manner may be a part of a heating, ventilation and air conditioning (HVAC) mechanism and/or a building automation system. Power transformation may be utilized in other components of the building automation system.

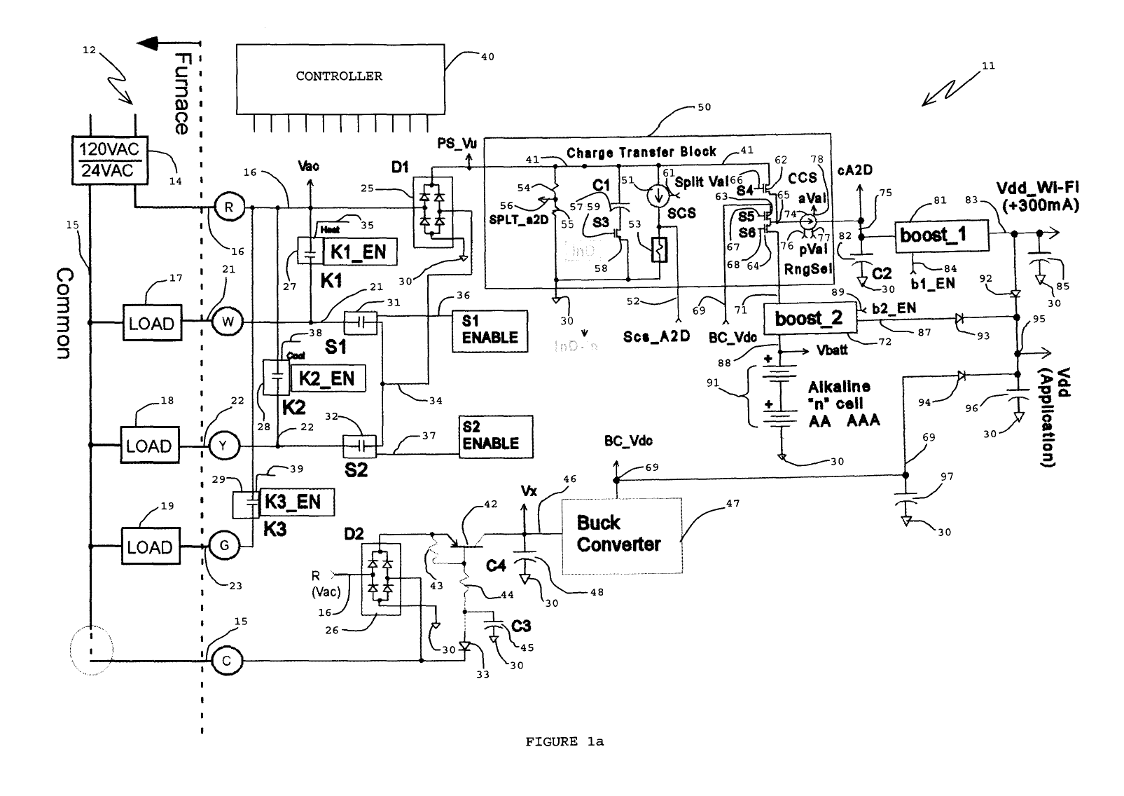

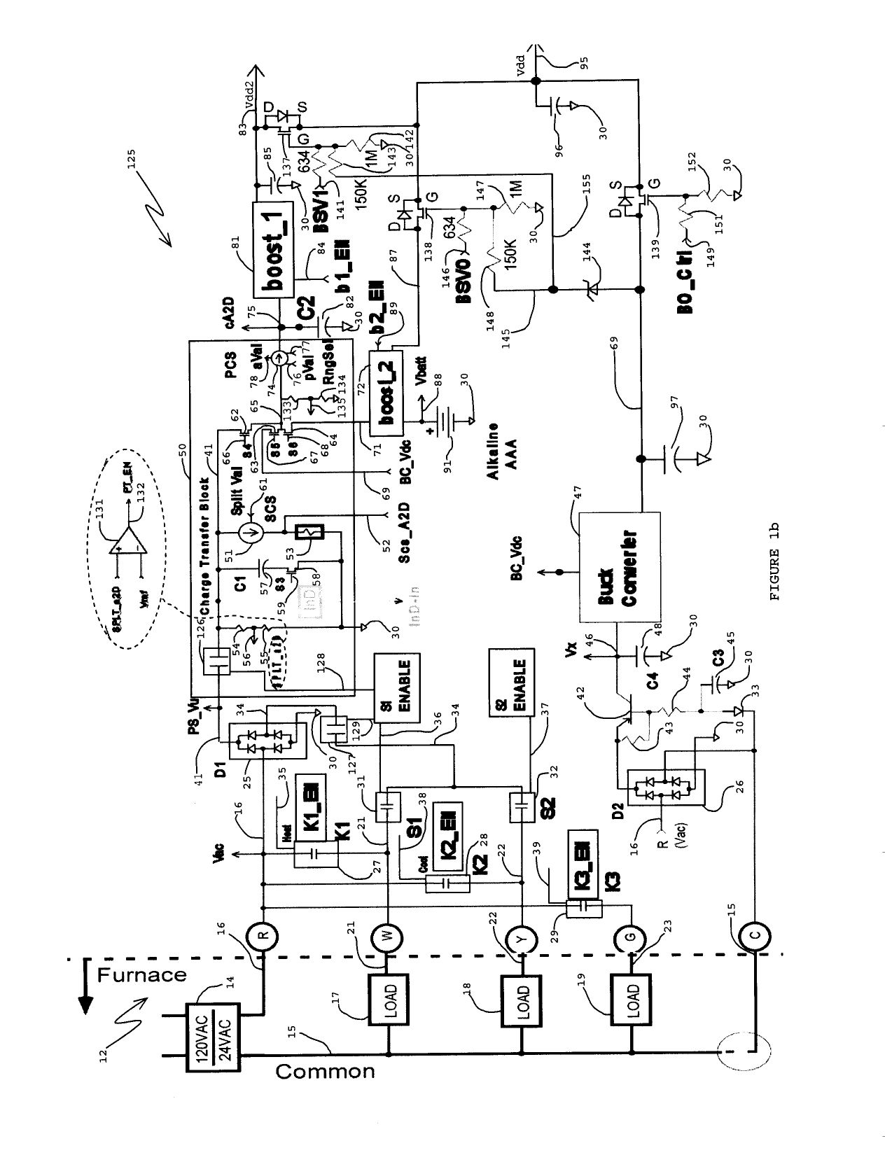

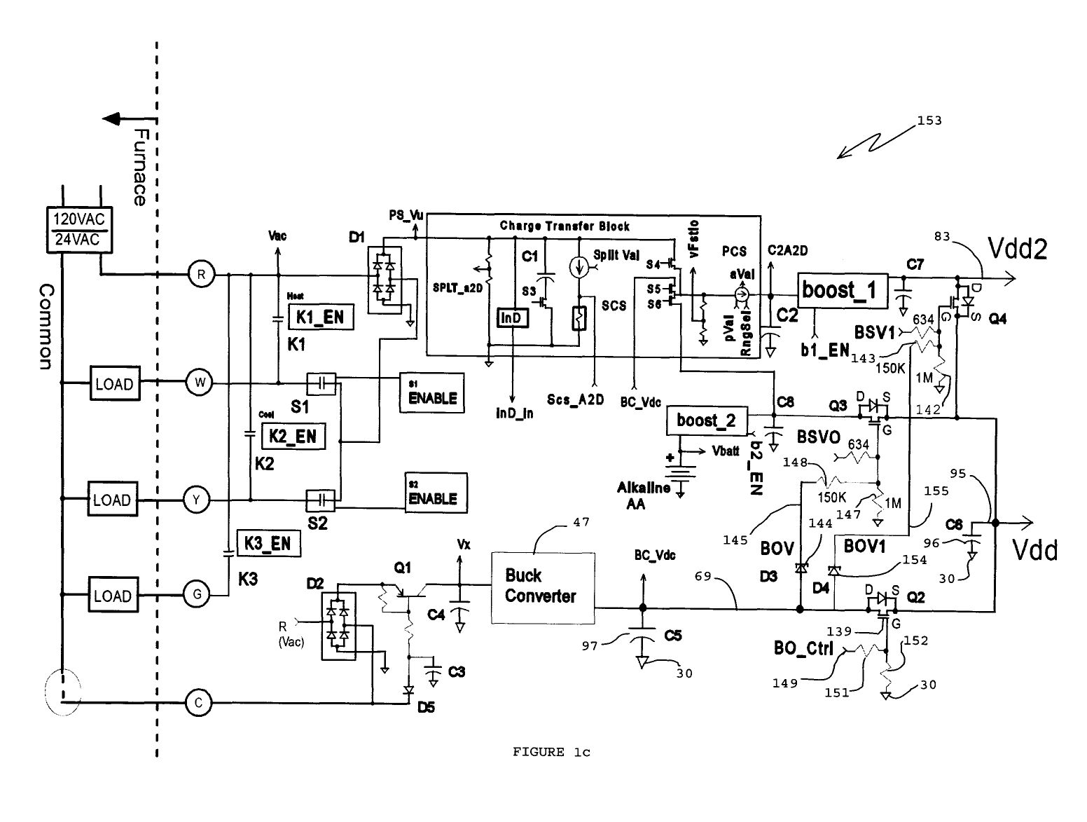

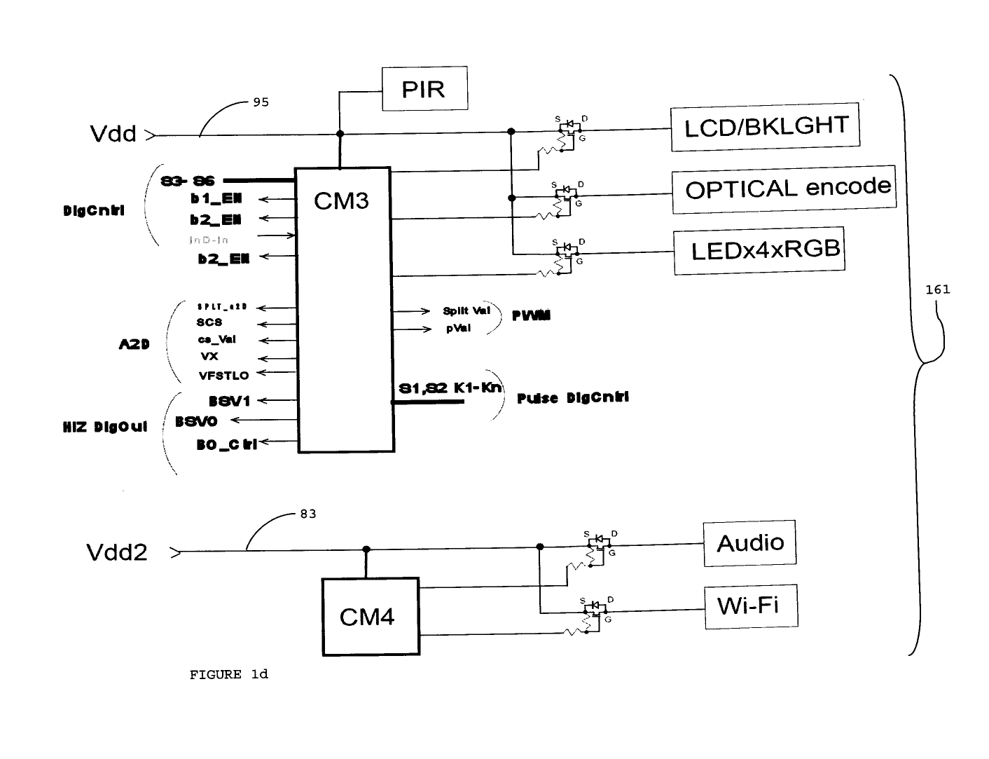

FIG. 1a is a diagram of a power transformation circuit 11. Circuit 11 may provide a way to charge an internal energy storage device, for instance, a capacitor 82, in a continuous manner. This behavior may occur in functional states of a load (17 or 18) having an “off” condition or an “on” condition. Energy may be delivered to a pre-storage device in a continuous manner relative to the impressed AC voltage. Related art systems may interrupt the load current to charge, i.e., to redirect the current into storage elements.

Since the present energy transfer approach, mechanism or block 50 may be continuous, no frequency or time dependency will necessarily exist as to when to interrupt the load current. Because the energy transfer is continuous, the overall currents may be much smaller than related-art power techniques. For example, a 16 mA pulse current for 1 m sec may essentially be the same as 1 mA taking over one entire line cycle at 60 Hz. The present approach may dramatically lower the probability of falsely tripping loads from an “off” state to an “on” state.

Power transformation topology of circuit 11 may allow energy to be drawn from two loads (e.g., loads 17 and 18) in a simultaneous fashion while the loads are in an “off” or “on” state. This may allow for a higher degree of load current to be transformed into a charging current.

Power transformation may precisely calculate the load impedance as a function of applied power frequency. A calculation may allow inductive or capacitive loads to be correctly categorized. Power transformation circuit 11 may be particularly interesting when one understands the capability that the transformation circuit 11 topology offers relative to the amount of energy that the circuit can transform into useable charging current. The topology may engage the load over a wide dynamic range (per application), transfer control of the AC load current to a programmable current source 51 while determining the load current directly. Subsequently, the system may transfer virtually all or portions of that current to a storage device 82 via a secondary charging current source (CCS) 78.

A secondary charging element may be chosen for a level arbitrarily. Charging currents are not necessarily inherently bound with the present topology. For instance, a value of 200 mA may allow for a satisfactory user experience.

The approach to balance the two programmable current sources 51 and 74 may also have a desired effect in that the current through the load is not necessarily altered other than having a minor loss of current due to an insertion of an applied voltage drop of power transformation circuit 11.

The present system may be in a particular class of power devices since charging currents up to 200 mA can be realized. A design of a secondary charging element may be artificially bound to a maximal level to protect the storage element.

As power transformation circuit 11 passes the entire load current from an internal activation switch to a saturated current source 51, power transformation device or charge transfer block 50 may need only to measure the current through current source 51, and calculate the effective impedance of the load via Ohm's law. A direct measurement may allow the device to set an “off” load condition that will not necessarily cause false load tripping. A direct determination may eliminate “trial” test current approaches or fixed approaches as known with related art systems. Current through source 51 may be determined by measuring the voltage drop across a 2.1 ohm resistor 53. Resistor 53 may be of another value.

Inductive relay loads may be known to exhibit a high degree of inrush current when they are activated. The inrush may occur during times when a physical armature in a load 17 or 18 is moving or is about to move. Over a life and application usage, the inrush component may increase. The effect may be dramatic when debris has become lodged in the device. It is not necessarily wise to limit such current in any manner since the device will not necessarily reach a satisfactory “on” state, or the device may chatter and ultimately lead to having contact failure. For this reason, the power transformation topology may use a parallel switch structure (i.e., switches 27 and 31 for load 17 and switches 28 and 32 for load 18) which is firstly engaged to power the loads.

The power transformation topology may determine whether the system is connected to an inductive load (e.g., a moveable armature) with several approaches. A determination may be important for setting the optimal value for an “off” state energy transformation. Independent of the inrush of a steady state AC current, a contactor relay load may be different when activated or not activated. The power transformation topology may have several mechanisms to deal with the discrepancy in order to increase the fidelity of charge rates. A measure of inductive impedance may be at a steady state against for an off cycle approach.

One mechanism is that a direct impedance calculation may be made when the relay is in an “on” state. When a device sets the “off” mode power transformation level, the device may test the desired voltage drop which actually occurred across the load. If the resultant drop is less than expected, then this means that an inductive load with an armature may certainly be present provided that the VAC is monitored and compensated for. The present power transformation system may easily compensate for the impedance difference.

Another mechanism may be able to derive that the armature has moved, by detection of a sudden impedance change through plausibility testing or direct observation. Either of these techniques may be invoked after determining if the split current source (SCS) has enough dynamic range to overcome the inrush of the contactor; otherwise, reliability of the system may be compromised. For this concern, a second option may be preferred at this time.

As to a first option, it may be possible to increment the first current source while observing the resultant current value. When one of the increments results in a slope inflection outside of what was previous predicted by past incremental changes, there may be an implication that an armature has been moved by a sudden impedance change. Otherwise, there may be a linear response.

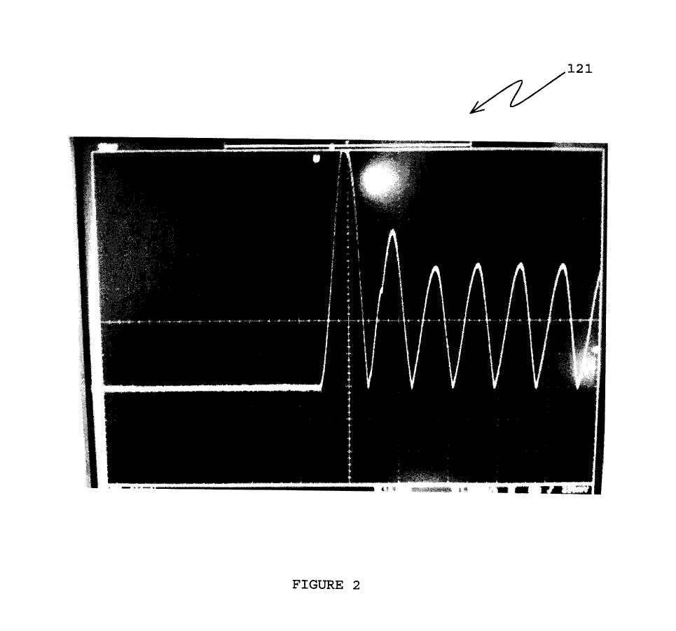

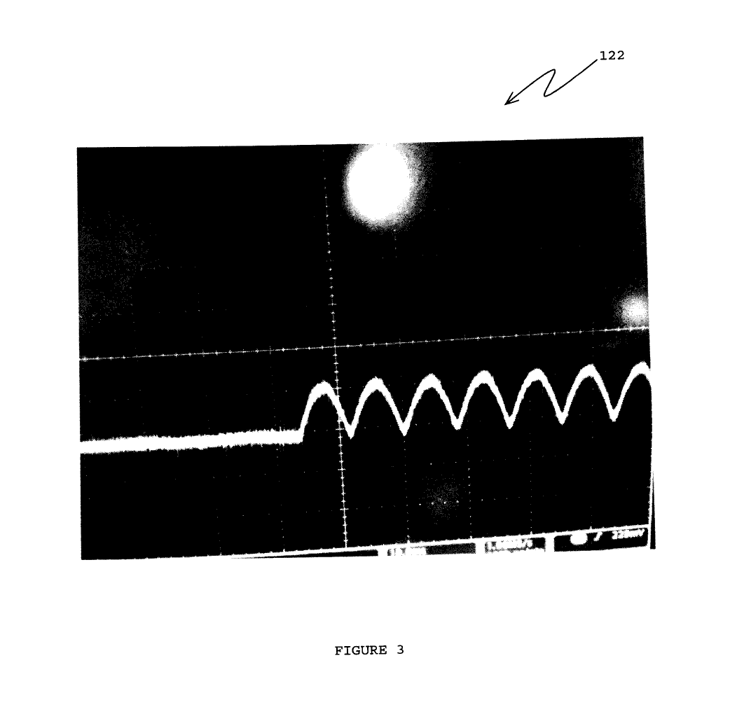

As to a second option, it may also be possible to apply the first current source at a maximal current level (saturated) and perform a fast A2D process on that resultant current wave form, to capture a step change that may have occurred in its response, as caused by an armature moving. FIGS. 2 and 3 are waveform diagrams that may illustrate the current waveform at an SCS_a2d (i.e., a connection between SCS 51 and resistor 53). The waveform diagram 121 of FIG. 2 may illustrate a case for an inductive load with armature movement shown. The waveform diagram 122 of FIG. 3 may demonstrate a case of a resistive load.

The waveforms of FIGS. 2 and 3 may illustrate that increasing the amount of charging current that a relay load can manage may be achieved with the load in an “off” state, since a primary technique of a direct impedance calculation may result in an impedance lower than what exists in the “off” state of the load. The measurement obtained with the direct impedance calculation may be safe from the perspective on being conservative so as not to cause false activation of loads.

An internal capacitance loading may cause losses in what can be transformed to energy storage. A loss may occur when a rectified voltage is impressed across a capacitor (for example, capacitor 57). The charging ripple current may be wasted back to a load as it cannot necessarily be converted to a charging current. One the other hand, the capacitance may help to balance the current though the secondary current source which aids an “on” cycle mode. Power transformation circuit 11 may utilize a FET 58 with a gate 59 control to introduce bulk capacitance when it is beneficial and eliminate the bulk capacitance when it is detrimental.

An approach may be utilized to determine load impedance. Impedance information may be used in a following manner. One may select a continuous (or pulsed) off cycle power level per terminal. That level should not exceed levels of a typical electronic interface logic circuit consistent with TTL or CMOS logic.

Split dynamic power transformation may allow energy to be harvested off a power line 16 when a load 17 or 18 is energized by the power line. A load of interest may be firstly selected by activating switch 31 or 32 (S1 or S2). Power transformation circuit 11 may then capture an A2D value on a Split_A2D at a connection point 56 of series connected resistors 54 and 55 forming a voltage divider between a rectifier output voltage line 41 and output reference line 30. The readings may have important information relative to the power transformation device.

One may determine if a load is connected to terminal 56 for Split_A2D, and provide directional information about the magnitude of the applied voltage, VAC, as indicated by voltage divider point 56 between resistors 54 and 55 and a load 17 and/or 18, except for some diode voltage drop in full-wave rectifier 25 (D1). The internal voltage divider impedance may be chosen to be at least two orders of magnitude higher than useful load values. The internal impedance values may be, for instance, 205K ohms and 14.7K ohms, as compared to loads in which useful energy can be derived may be from 10 to 2K ohms at 60 Hertz. One may see from an inspection that the load impedance does not necessarily significantly alter a present view point of VAC based on an authority of an external network. The diode network influence of rectifier 25 may provide some compensation as the current through the network is bound and dominated by an internal resistor network. System 11 may indicate a power transformation error if the value returned indicates that the load is too high or the VAC is too low.

A load of interest may be completely energized by a parallel load control device 27 and/or 28 (K1 and/or K2). SCS 51 may be configured to a saturated condition with respect to its drop introduced against load 17 and/or 18. Switch 27 and/or 28 (K(n)) may then be deselected and the load current may be transferred to internal SCS 51 in its entirety. The value of the current may be determined by a direct reading of SCS_a2d at the connection point of SCS 51 and resistor 53. With this reading (and VAC bound from the reading determined above), the impedance of load 17 and/or 18 may be closely estimated using Ohm's law. That may be indicated by the voltage of line 41 as determined by divider combination of resistors 54 and 55 divided by the current indicated by the voltage across resistor 53. That value may be used for an “off” cycle power transformation and the VAC may be recorded and tracked on a periodic basis.

Power transformation may incorporate a special network to speed up the process to transition from the fully saturated condition to a level where the split current source (SCS) 51 comes out of saturation. The behavior of a new circuit, IND, may allow SCS 51 to find the point at which perturbation in a load 17 and/or 18 connected line can occur because of a present configuration relative to a rectified and non-filtered voltage being applied to a current source working with a dc bias op-amp. Op-amp overshoot during the valleys associated with the applied VAC may cause current injection which in-turn can cause line perturbation which directly indicates that the SCS 51 is coming out of saturation. Once this point is determined, the pulse width modulation (PWM) signal to an input 61 of SCS 51 may be increased slightly to stop the firing of the IND and a bulk capacitor 51 may be activated to smooth out the applied voltage presented to SCS 51. SCS 51 may be further eased out of saturation as part of the next step.

The IND circuit may eliminate a need to perform an a2d conversation with stabilization times involved after each incremental value.

A CCS 74 may reside in parallel with the SCS 51. An initial value may be programmed in CCS 74. The SCS 51 circuit may be connected across CCS 74 by activating FET 62 (S4) in a high bias mode.

The PWM value to line 61 of SCS 51 may be lowered until SCS 51 comes out of saturation and a value of about a 3.0 VDC drop is achieved across SCS 51 and in turn CCS 74. Therefore, the current through the split current source 51 may be transferred to charging current via CCS 74. Depending on the load, SCS 51 may go to zero or remain active such that the current through load 17 and/or 18 is not necessarily affected other than by an introduction of a drop across the internal network of block 50. The drop may incorporate rectifier (D1) or a programmable AC switch 25. Rectifier 25 may utilize Schottky diodes which result in fewer effects than ordinary non-Schottky diodes. The drop of switch (S4) 62 may be calibrated out.

FIG. 1b is a diagram of circuit 125 that may be similar to circuit 11 of FIG. 1a. The single S1 switch 31 may be substituted with a two S1 switches 126 and 127. These switches may be enabled by lines 128 and 129, respectively.

At the voltage divider of resistors 54 and 55 with a line 56 at the junction of resistors 54 and 55, a comparator 131 may have a non-inverting input connected to line 56, and an inverting input connected to a voltage reference. An output 132 of comparator 131 may indicate with a binary signal PT_EN whether the voltage at line 56 is below, meets or exceeds the voltage reference. Resistors 54 and 55 may have high resistance with the comparator 131 and thus be quite a low current drain on line 41 of the charge transfer block 50.

Another voltage divider having resistor 133 connected to line 5 and resistor 134 connected to ground 30, with a line 135 connected to a junction of resistors 133 and 134. Line 135 may be connected to a comparator like the arrangement of comparator 131.

Battery 91 may be a single battery or a multitude of them. The battery may be a non-rechargeable or a rechargeable one with appropriate charging circuitry.

Diodes 92, 93 and 94 in circuit 11 may be replaced with FET switches 137, 138 and 139, respectively, in circuit 125. The drain of FET 137 may be connected to line 83 the source may be connected to line 95 of the Vdd output. A control signal may go to an input via a 634 ohm resistor 141 to the gate of FET 137. The gate may be connected to ground 30 via a one meg-ohm resistor 142. The gate may also be connected to a line 69 of an output of buck converter 47, via a 150 kilo-ohm resistor 143, lines 155 and 145 and a zener diode 144. The anode of diode 144 may be connected to line 69.

A control signal may go to an input 146 via a 634 ohm resistor to the gate of FET 138. The gate may also be connected to line 145 via a 150 kilo-ohm resistor 148. The drain of FET 138 may be connected to a ground 30 via a one-meg-ohm resistor 147. The source may be connected to line 95.

A control signal may go to an input 149 via a resistor 151 to FET 139. The gate may be connected to ground 30 via a resistor 152. The drain may be connected to line 69 and the source may be connected to line 95.

The power transformation approach may incorporate a FET logic control to improve the various modes needed by the application in order to power at least two power rails; VDD and VDD2.

BSV1, BSV0, BO_Ctrl may be configured to be connected to pins of micro controller that are Hi Z at power up

B2_en may have an integral pull up such as high (active) any time a battery is installed.

Function split_A2D may be run with a discrete go no-go circuit; in this case, the micro controller pin may read it as a general IO instead of an A2d process.

FIG. 1c is a diagram of a circuit 153 which may be similar to circuit 125 of FIG. 1b. Line 155 is disconnected from line 145 and connected to a cathode of a zener diode 154. An anode of zener diode 154 may be connected to line 169. Many of the unnumbered components of circuit 153 may have the same numerical designations as those components of circuit 125 in FIG. 1b.

FIG. 1d is a diagram of loads 161 that may be connected to output lines 83 and 95 of circuits 11, 125 and 153 in FIGS. 1a, 1b and 1c, respectively. Loads 161 may incorporate some processor control relative to the power transformation circuits 11, 125 and 153.

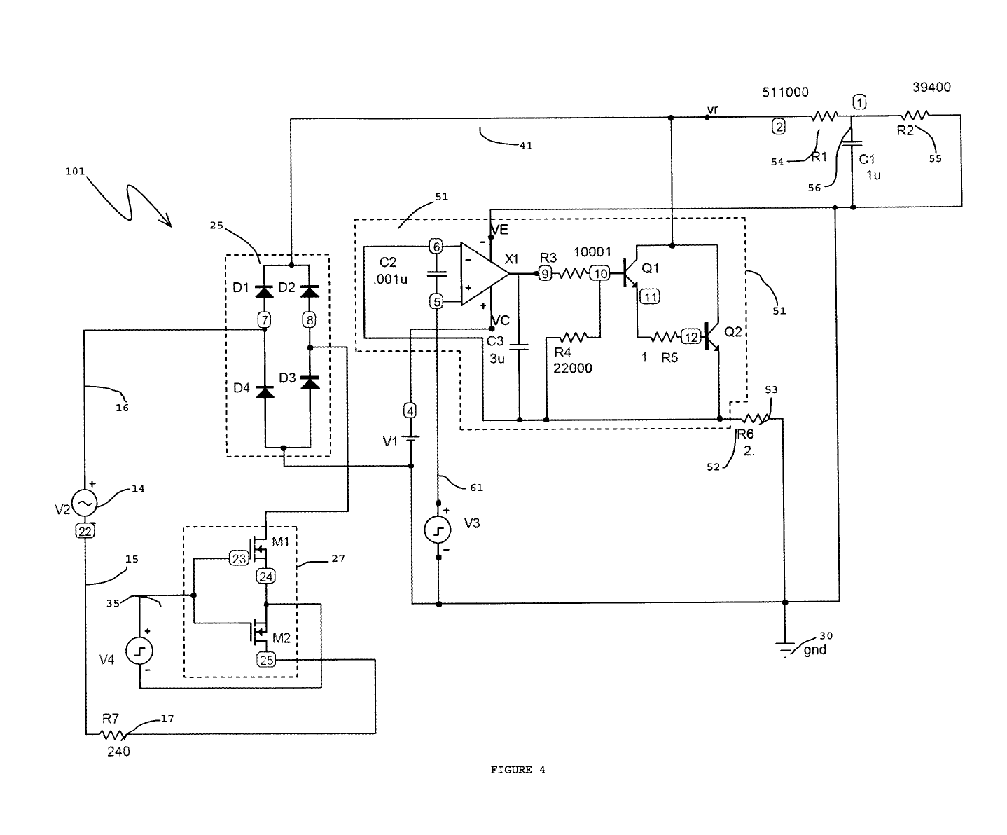

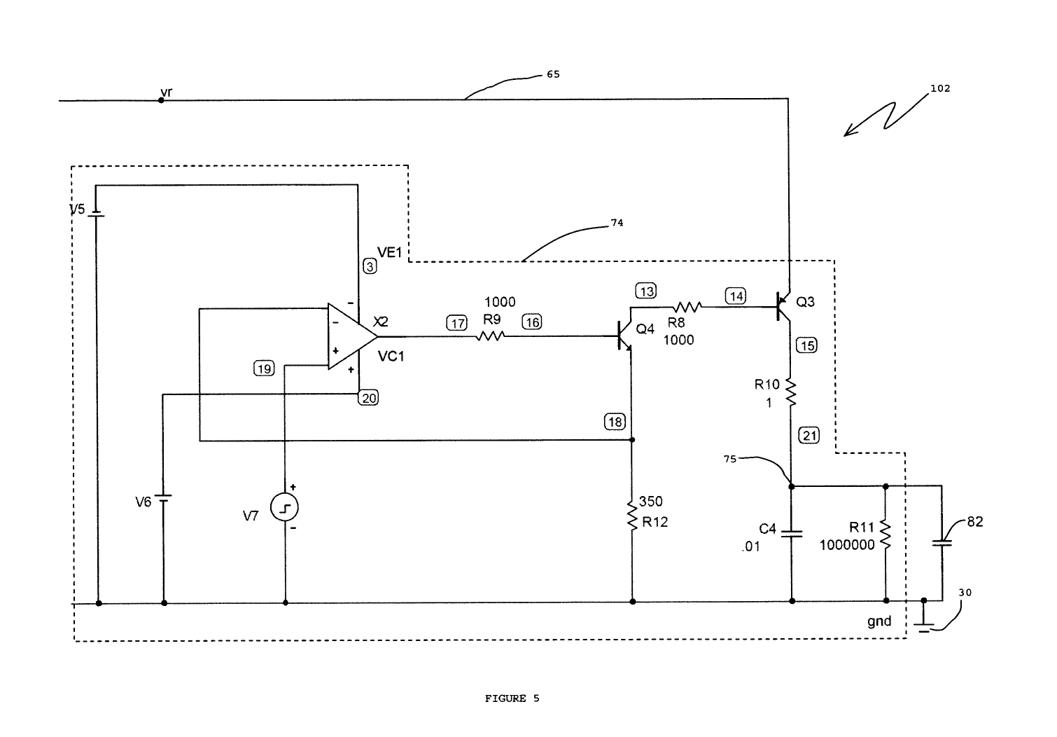

FIGS. 4 and 5 are schematic diagrams 101 and 102 of current sources 51 and 74, respectively.

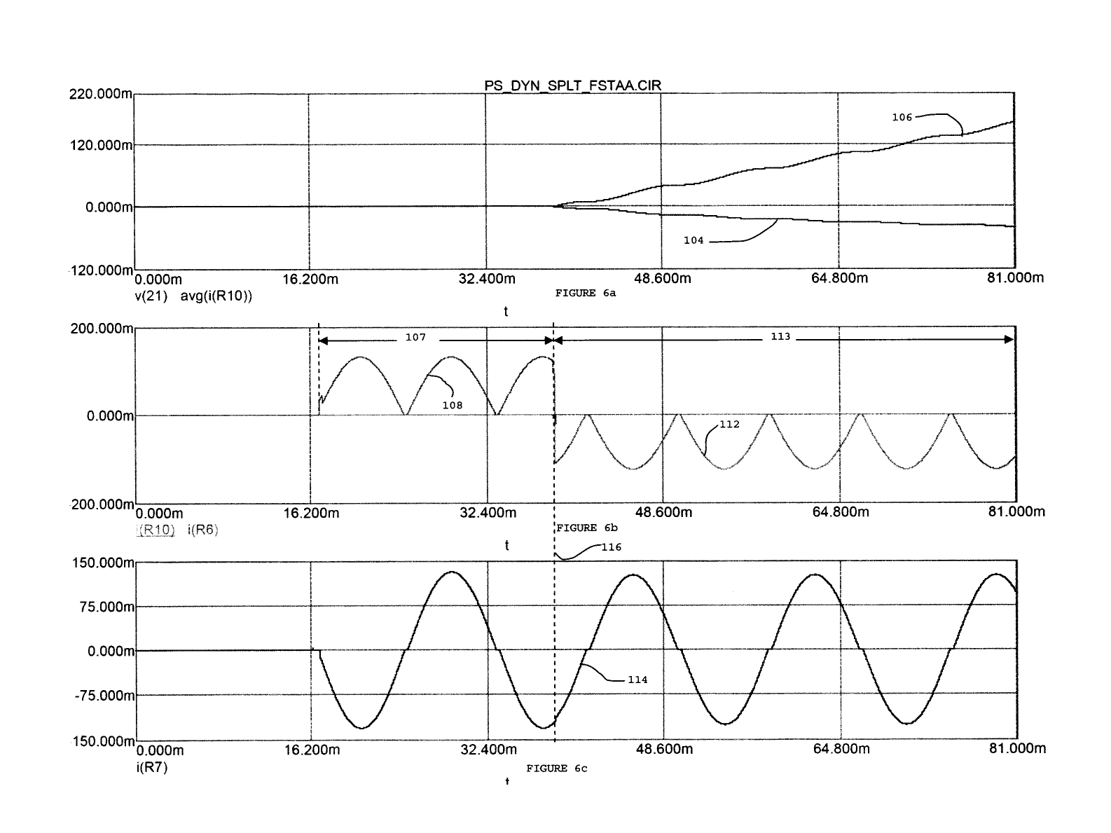

FIGS. 6a, 6b and 6c are diagrams of simulated waveforms. A graphical simulation may illustrate the charging current 104 on line 75 of FIGS. 1a-1c and 5 as shown in the waveform of FIG. 6a. Waveform 106 is the voltage on line 75 for charging current. A current transformation of current 104 is shown in a diagram of FIG. 6b. SCS 51 may have control of the load current as measured voltage drops 108 across resistor 53 at a first part of the waveform. Line 112 may represent the current to CCS 74. Waveforms 108 and 112 may represent a range current. The 112 waveform of currents may be measured at line 75 of FIGS. 1a-1c and 5.

Virtually all of the available current may be transferred to CCS 74 at line cycles 113 after a few line cycles 107. A diagram of FIG. 6c shows waveform 114 of voltage across load 17 which may indicate load 17 current for a range of charging current. A summed load current does not necessarily change in any manner during a transition 116 from line cycles 107 to line cycles 113. Thus, with load activation by switch 27 or 28 (K1 or K2), the current through load 17 or 18, respectively, at point 56 may be proportional to the applied VAC.

At this stage, VAC changes may be monitored at point 56 and values of SCS 51 and CCS 74 altered. Typically, there may be more interest in a loss of AC or brown out conditions where system operation could be terminated. The charging process may be modulated by tuning the increasing of the value of SCS 51 and/or reducing the value of a CCS 74, or typically doing both. The charging process may be completely terminated by reselecting switch 27 or 28 (K(n)), respectively, to return the load 17 or 18 to an un-fettered state.

Charge transfer block 50 may have other features. Load currents may be high as compared to what could exist on line 83 when Wi-Fi and high powered engines involving voice or displays are present. Related-art systems may typically make the user wait while charging the internal storage device to the point where it can support local processes. The present power transformation system 11 may incorporate an approach to “fast” charge the system from a replaceable energy storage device 91 such as an alkaline or lithium battery. An “n” farad ultra capacitor 82 (C2), or super-capacitor, may gain enough charge to support the Wi-Fi access point and let one run a display system, in a matter of, for instance, one to ten seconds rather than, for instance, 20 to 40 minutes. “n” may indicate a number of farads for capacitor 82.

An ultra capacitor may be regarded as, for example, a super capacitor, electrochemical capacitor, or an electric double layer capacitor. The ultra capacitor may be made from, for instance, carbon aerogel, carbon nanotubes, or highly porous electrode materials, or other materials that can result in extremely high capacitance within a small package. Such capacitance may range from one-half farad to 200 farads or more. Depending on the power output requirements of system 11 from capacitive storage, the capacitance of the capacitor 82 might be less than one-half farad in certain designs.

Capacitor 82 may be a single capacitor or a multitude of capacitors connected in a parallel and/or a series configuration. Generally, the number of farads of capacitor 82 may be one or greater than one. In the present instance, the number of farads of capacitor 82 may be five.

Replaceable battery 91 may be tapped at other times when power transformation techniques are not necessarily deriving enough energy dependent on intermittent usage, such as may occur with voice or code down load periods.

A last element of charge transfer block 50 may be an approach to allow a common connected device to utilize the charging system or at least inform the power transformation that its features may be needed.

The topology of FIG. 1a may allow a buck converter 47 have less dynamic range as it merely would need to support fast charge rates and not necessarily need to be rated up to 300 mA as what might be needed for voice, display and Wi-Fi systems.

Other ancillary functions may be incorporated. It may be advantageous to incorporate a CCS 74 rate monitor sub-circuit to eliminate calibration issues associated with the current source over its input voltage compliance range. This may be particularly useful when the CCS 74 is used in the high voltage mode associated with an “Off” load power transformation.

System 11 may have a sub-circuit to monitor changes in applied VAC. The sub-circuit may improve the fidelity of the system and eliminate extensive tolerance analysis.

FIG. 1a is a diagram of a power transformation system 11. A furnace system 12 showing a step-down 120/24 VAC transformer 14 may have a common line 15 and a 24 VAC hot line 16. Common line 15 may be regarded as a ground or reference voltage for furnace system 12. Also, common line 15 may be connected to one side of loads 17, 18 and 19. Loads 17, 18 and 19 may have another side connected to lines 21, 22 and 23, respectively. Loads 17, 18 and 19 may relate to heating, air conditioning, and ventilation, respectively. The loads may instead relate to other kinds of components. Terminals connecting lines 16, 21, 22, 23 and 15 between furnace 12 and power transformation system 11 may be labeled “R”, “W”, “Y”, “G” and “C”, respectively.

Line 16 may be connected to a first terminal of a full wave rectifier 25, a first terminal of a full-wave rectifier 26, a first terminal of a relay 27, a first terminal of a relay 28 and a first terminal of a relay 29.

Line 21 may be connected to a second terminal of relay 27 and a first terminal of a relay 31. Line 22 may be connected to a second terminal of relay 28 and a first terminal of a relay 32. Line 23 may be connected to a second terminal of relay 29. Line 15 may be connected to a second terminal of full-wave rectifier 26 and to a cathode of a diode 33. A second terminal of full-wave rectifier 25 may be connected to a second terminal of relay 31 and a second terminal of relay 32 via a line 34.

Relay 27 may be controlled by a signal from a controller 40 via a line 35. Relay 31 may be controlled by a signal from controller 40 via a line 36. Relay 32 may be controlled by a signal from controller 40 via a line 37. Relay 28 may be controlled by a signal from controller 40 via a line 38. Relay 29 may be controlled by a signal from controller 40 via a line 39.

Rectifiers 25 and 26 may be configured with various layouts. An example circuit for the rectifiers may incorporate also third and fourth terminals. A first diode and a second diode may have cathodes connected to the third terminal. The first diode may have an anode connected to the first terminal and the second diode may have an anode connected to the second terminal. A third diode and a fourth diode may have cathodes connected to the fourth terminal. The third diode may have an anode connected to the first terminal. The fourth diode may have an anode connected to the second terminal.

The third terminals of rectifiers 25 and 26 may be connected to a common ground or reference voltage terminal 30 of power transformation system 11. The fourth terminal of rectifier 25 may be connected to a line 41 to a charge transfer block 50. The fourth terminal of rectifier 26 may be connected to an emitter of a PNP transistor 42.

A resistor 43 may have a first end connected to the emitter of transistor 42 and a second end connected to a base of transistor 42. A resistor 44 may have a first end connected to the base of transistor 42 and a second end connected an anode of diode 33. A capacitor 45 may have a first terminal connected to the anode of diode 33 and a second terminal connected to ground 30. A collector of transistor 42 may be connected to a line 46 to an input of a buck converter 47. A capacitor 48 may have a first terminal connected to the collector of transistor 42 and a second terminal connected to ground 30.

Charge transfer block 50 may incorporate a split current source 51 having a first terminal connected to line 41 and a second terminal connected to a line 52. Line 52 may be connected to first end of a low ohm (2.5Ω) resistor 53. A second end of resistor 53 may be connected to ground 30. An input for a value to current source 51 may be provided on line 61 to source 51.

Block 50 may incorporate a voltage divider having a resistor 54 and a resistor 55. Resistor 54 may have a first end connected to line 41 and a second end connected to a line 56 and to a first end of resistor 55. Resistor 55 may have a second end connected to ground 30.

Block 50 may incorporate a capacitor 57 having a first terminal connected to line 41. Capacitor 57 may have a second terminal connected to a first terminal of a FET or switch 58. A second terminal of switch 58 may be connected to ground 30. Switch 58 may be controlled by a signal from controller 40 via a line 59 to s gate or control terminal of FET or switch 58.

A FET or switch 62 may have a first terminal connected to line 41 and a second terminal connected to a line 65. FET or switch 62 may have a gate or third terminal connected to a line 66 for receiving a signal to control FET or switch 62. A FET or switch 63 may have a first terminal connected to a line 69 which is connected to an output of buck converter 47. Switch 63 may have a second terminal connected to line 65. A gate of third terminal of FET or switch 63 may be connected to a line 67 for receiving a signal to control switch 63. A FET or switch 64 may have a first terminal connected to line 65 and have a second terminal connected to a line 71. Line 71 may be connected to a first terminal of a boost circuit 72. A gate or third terminal of FET or switch 64 may be connected to a line 68 for receiving a signal to control switch 64.

A programmable current source 74 may have a first terminal connected to line 65. Source 74 may have a second terminal connected to a line 75. A third terminal and a fourth terminal may be connected to a line 76 and a line 77, respectively for inputs to source 74 for setting a range. A fifth terminal may be connected to a line 78 for providing an output indication from source 74.

A capacitor 82 may have a first terminal connected to line 75 and a second terminal connected to ground 30. A boost circuit 81 may have a first terminal connected to line 75. A second terminal of boost circuit 81 may be connected to an output line 83. A third terminal of boost circuit 81 may be connected to a line 84 which can provide a signal for controlling circuit 81.

A capacitor 85 may have a first terminal connected to line 83 and a second terminal connected to ground 30.

Boost circuit 72 may have a second terminal connected to a line 88. A third terminal of boost circuit 72 may be connected to an output line 87. A fourth terminal of boost circuit 72 may be connected to a line 89 which can provide a signal for controlling circuit 72. A battery assembly 91 may have a positive terminal connected to line 88 and a negative terminal connected to ground 30.

Output line 83 may be connected to an anode of a diode 92. Output line 87 may be connected to an anode of a diode 93. Line 69 from an output of converter 47 may be connected to an anode of a diode 94. Cathodes of diodes 92, 93 and 94 may connected to an output line 95. A capacitor 96 may have a first terminal connected to line 95 and a second terminal connected to ground 30. A capacitor 97 may have a first terminal connected to line 69 and a second terminal connected to ground 30.

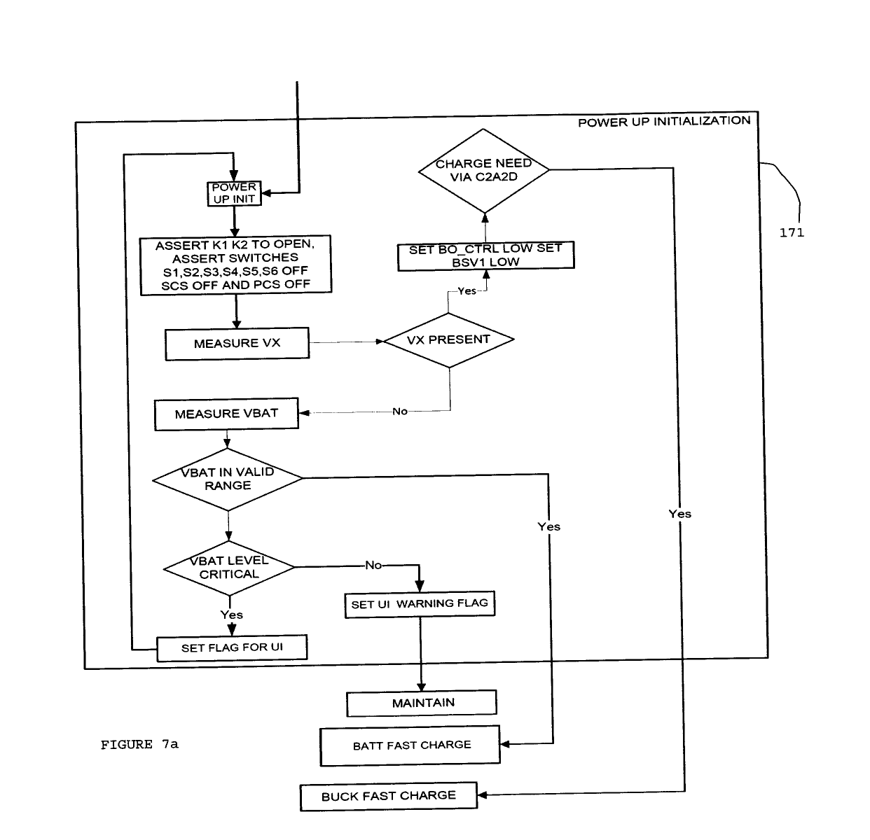

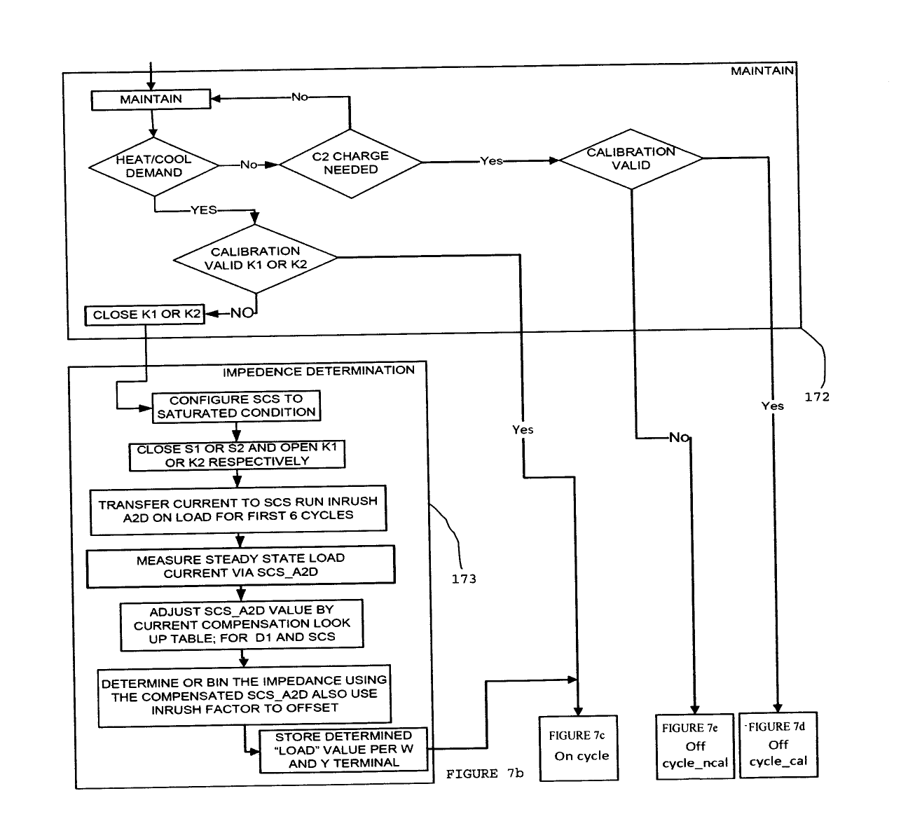

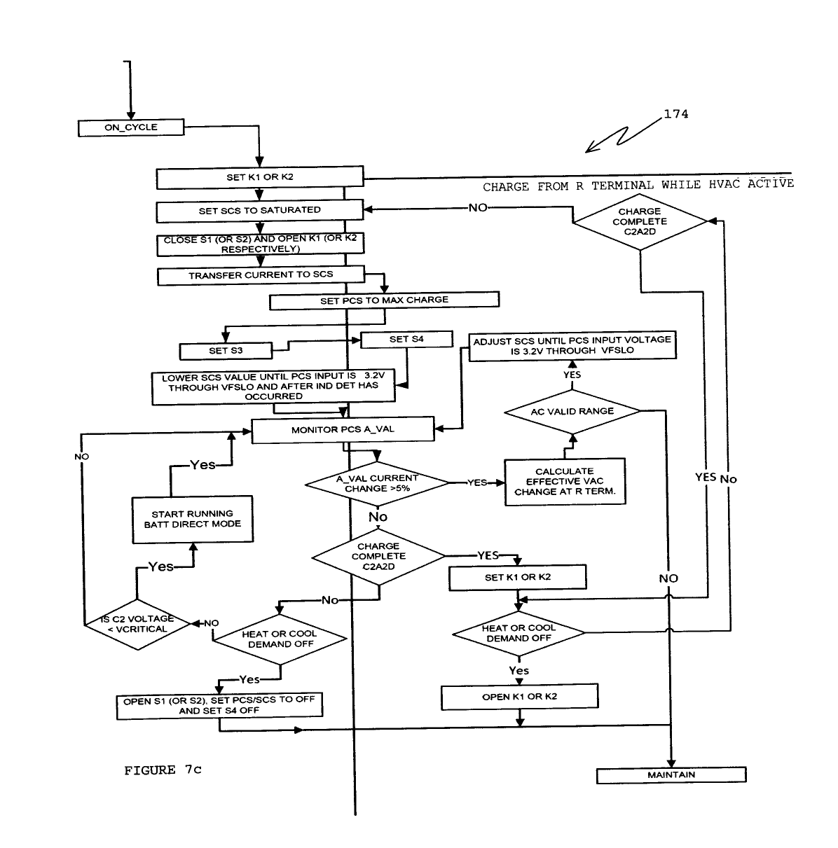

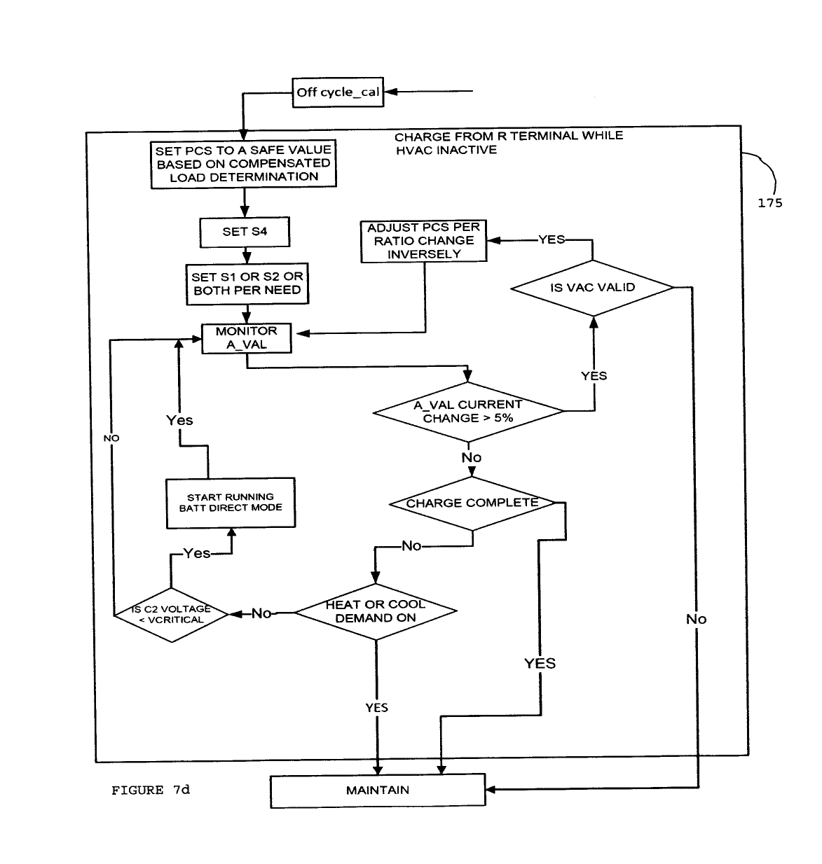

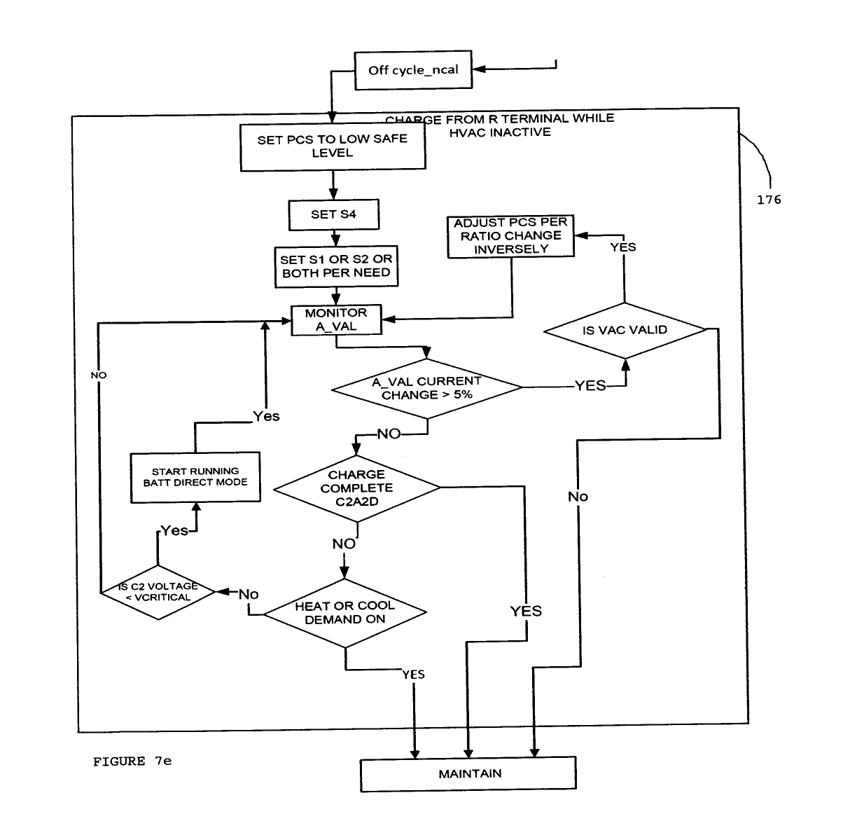

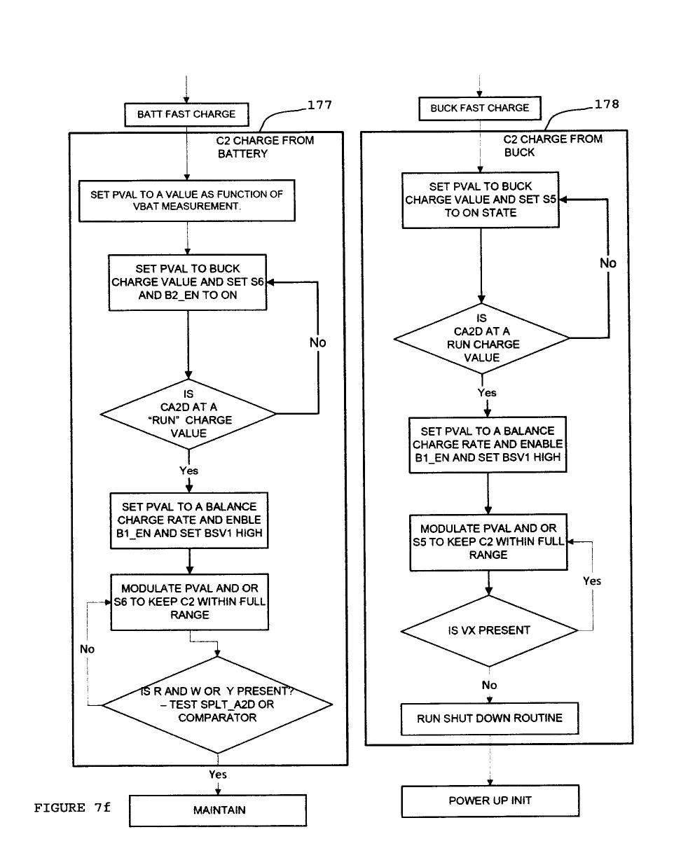

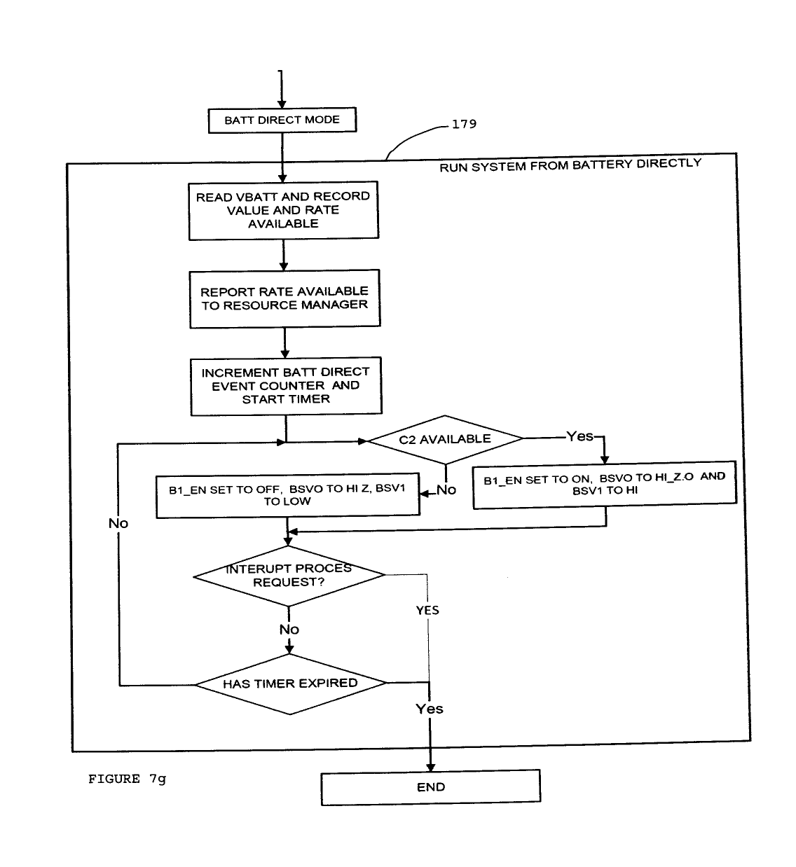

FIGS. 7a, 7b, 7c, 7d, 7e, 7f and 7g are diagrams of activities of certain portions of the power transformation circuits in FIGS. 1a-1c. Referral to letter, alphanumeric or numeric designations in FIGS. 1a-1d may be made in FIGS. 7a-7g. FIG. 7a is a diagram revealing an approach 171 for a power up initialization. FIG. 7b is a diagram for an approach 172 to maintain and an approach 173 for an impedance determination. FIG. 7c is a diagram for an approach 174 for a charge from R terminal while an HVAC is active. FIG. 7d is a diagram for an approach 175 for a charge from R terminal while the HVAC is inactive. FIG. 7e is a diagram for another approach 176 for a charge from R terminal while the HVAC is inactive. FIG. 7f is a diagram of an approach 177 for a C2 charge from a battery and an approach 178 for a C2 charge from a buck converter.

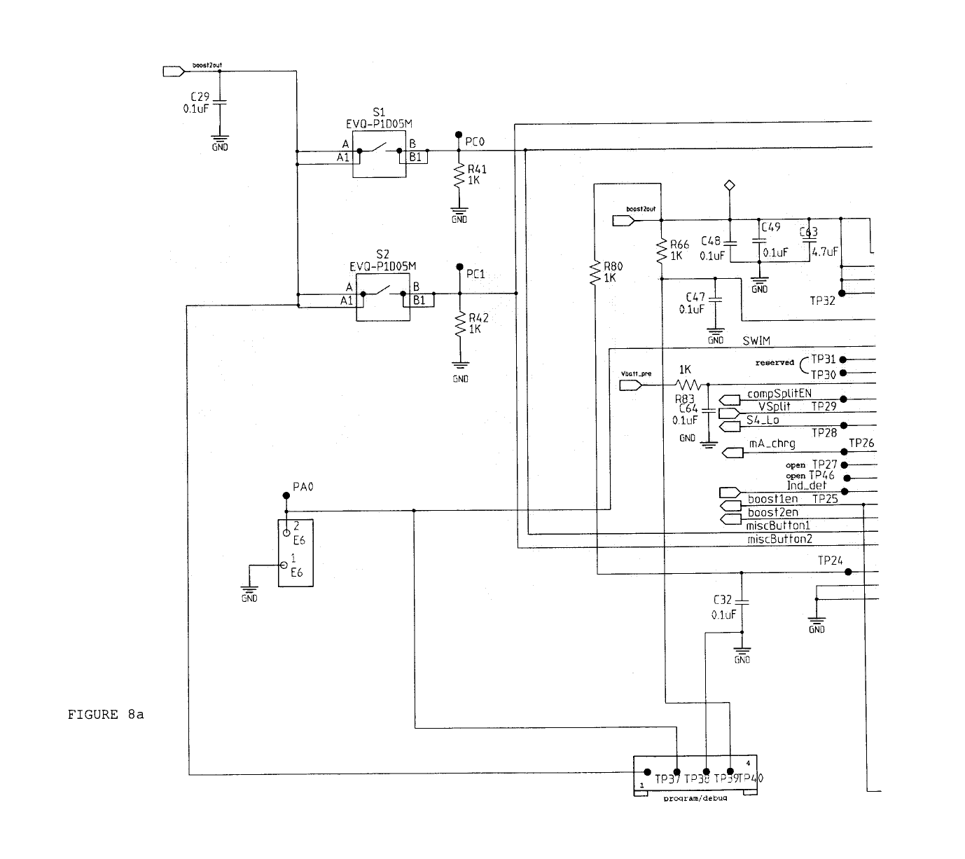

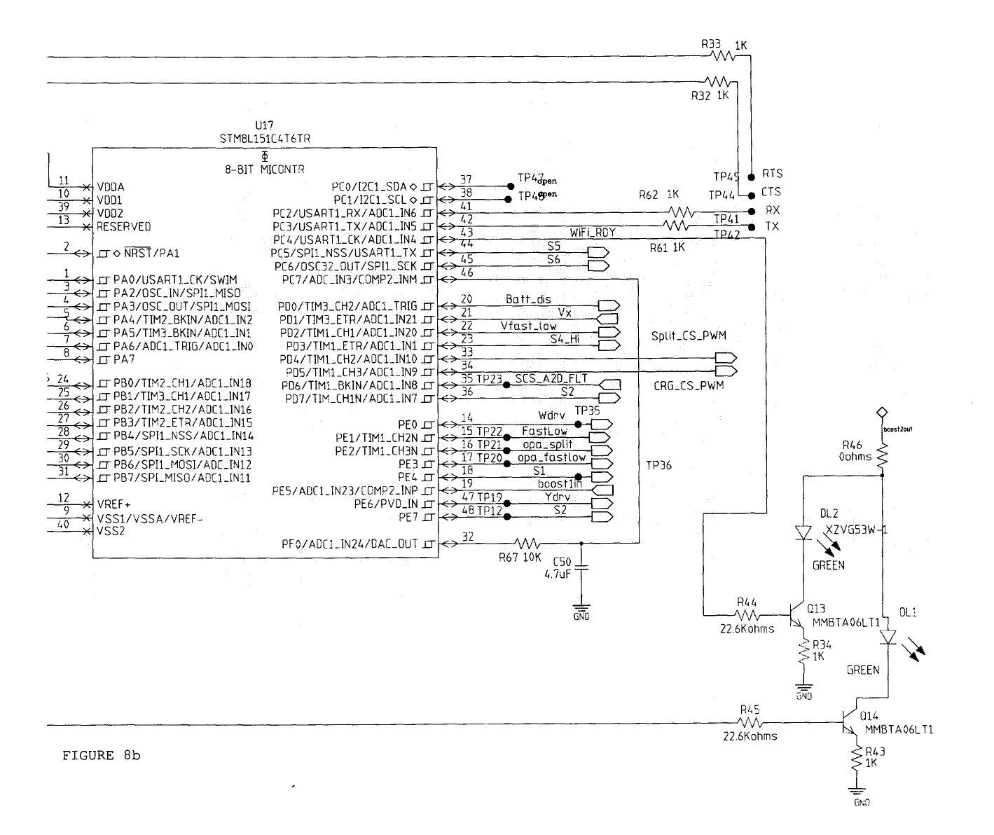

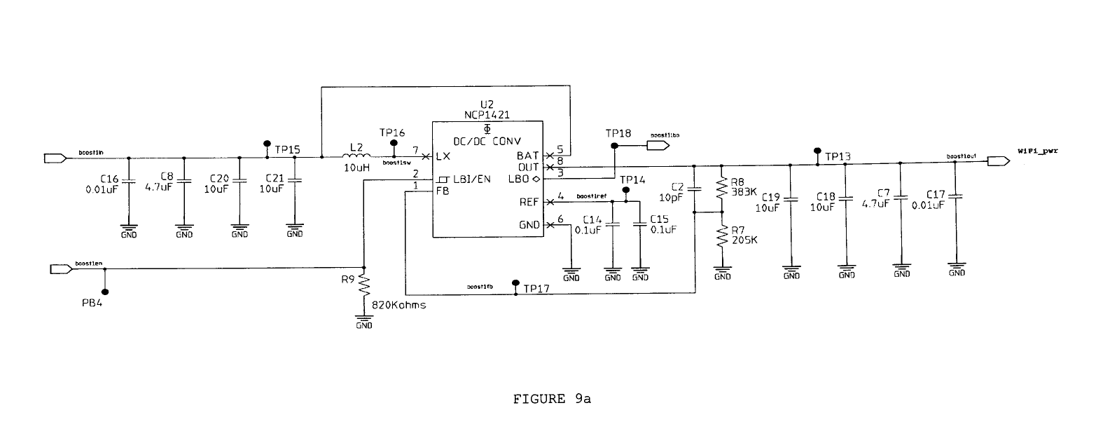

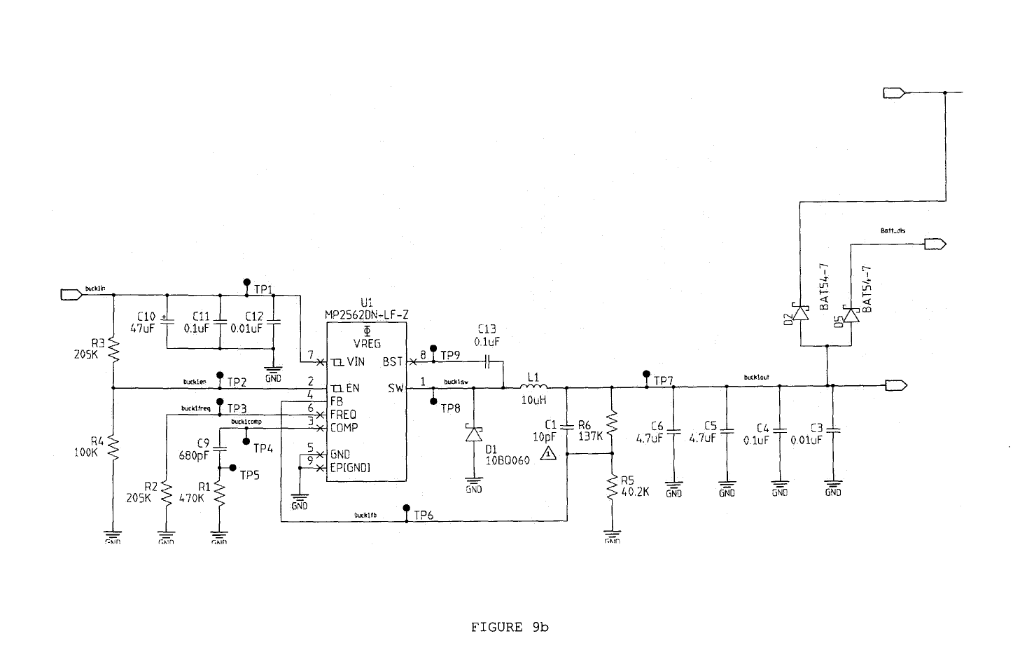

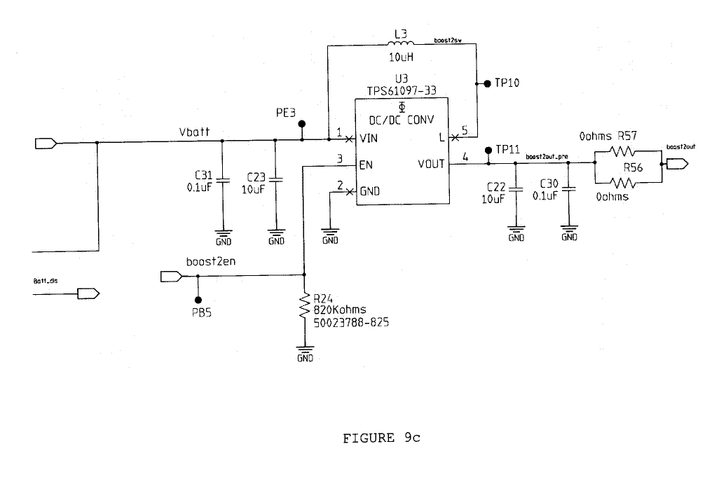

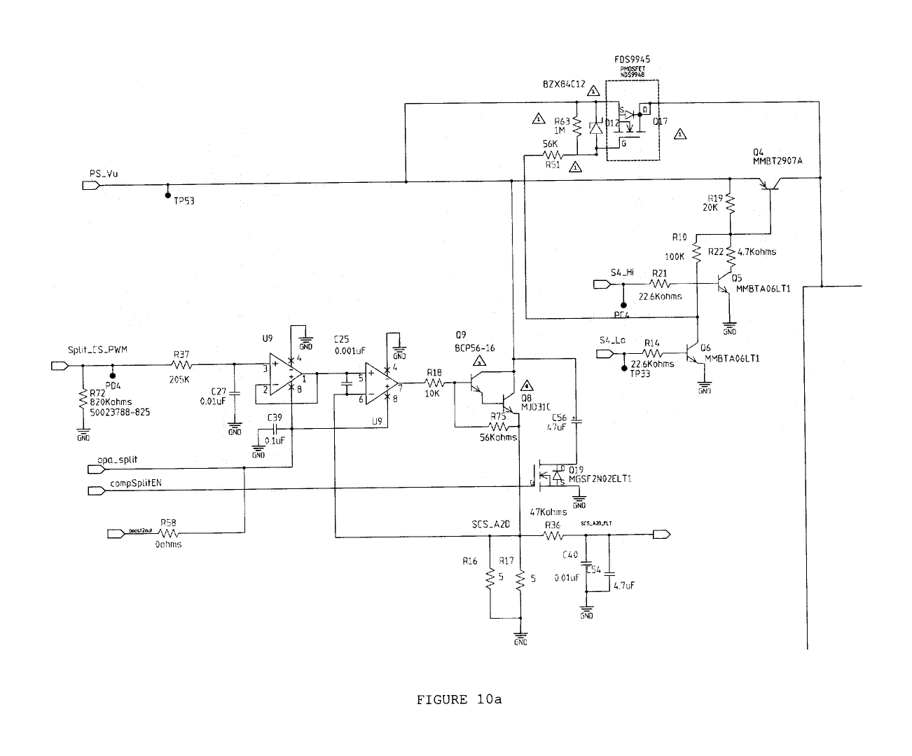

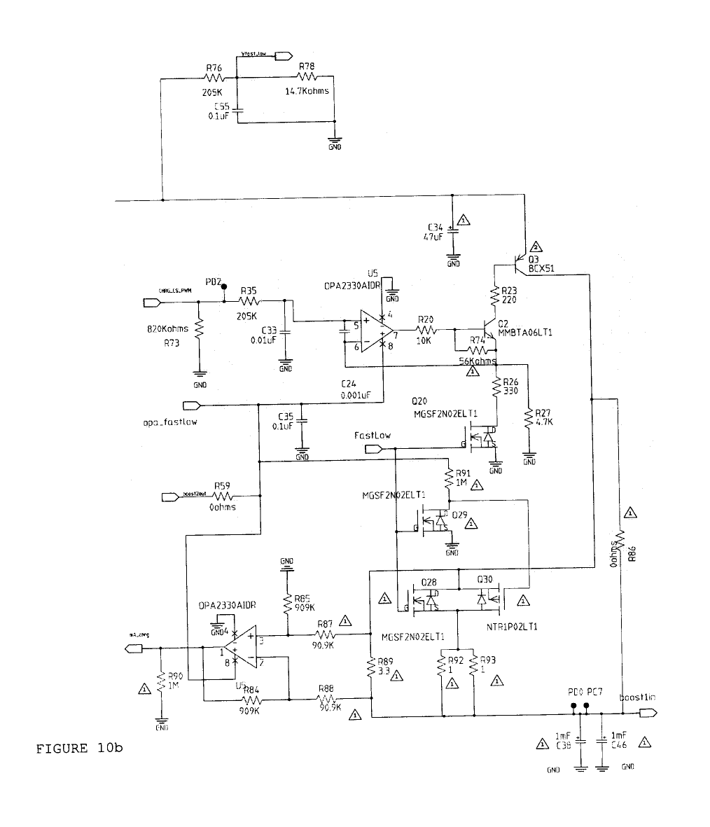

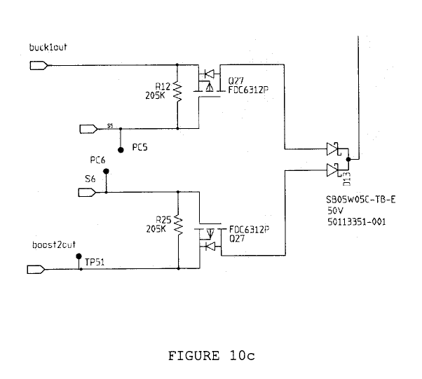

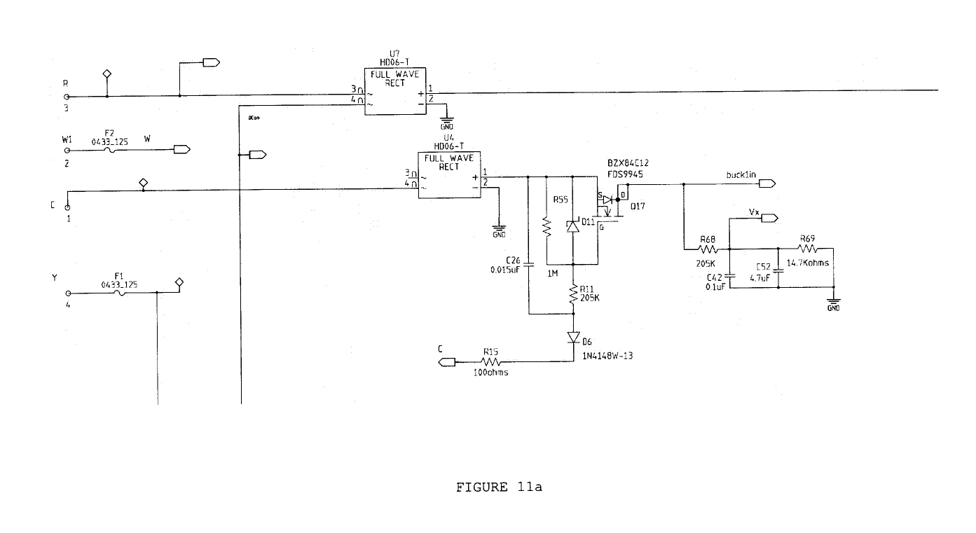

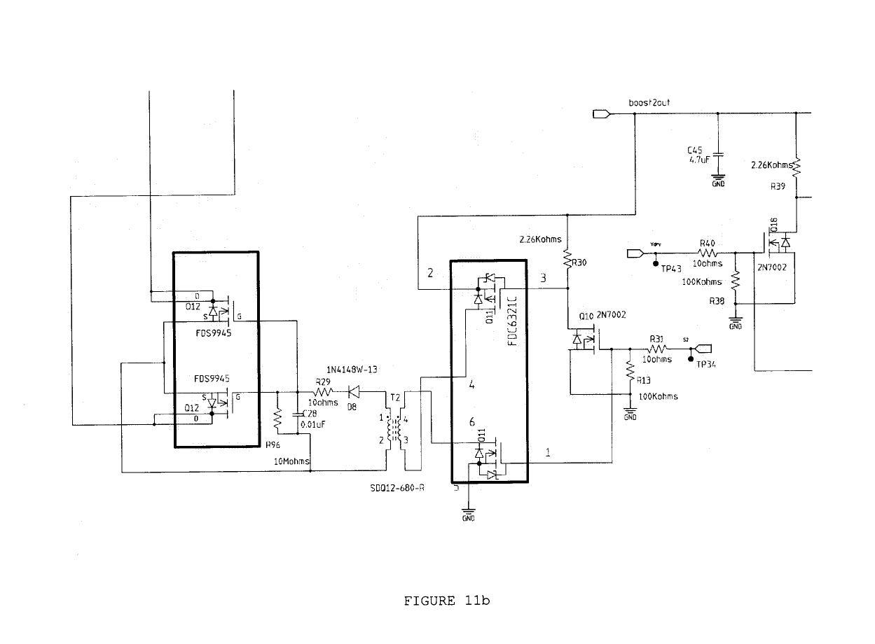

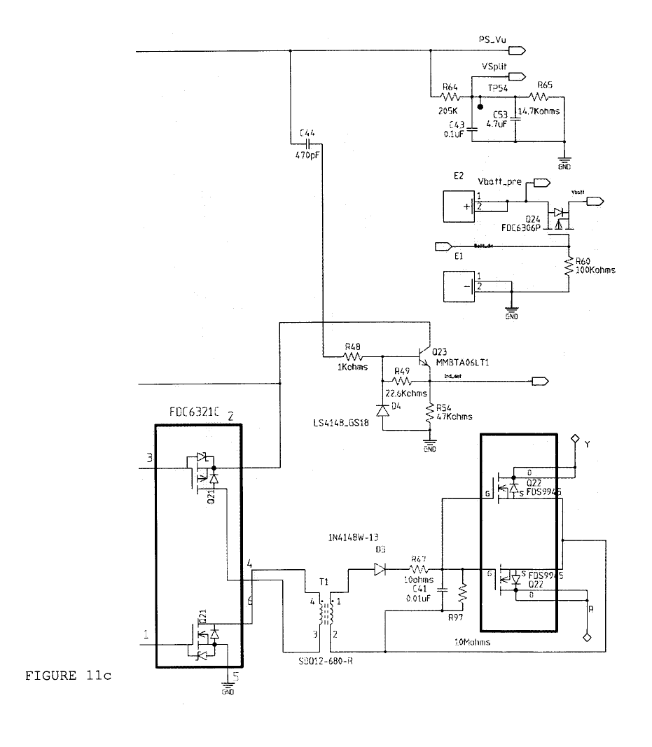

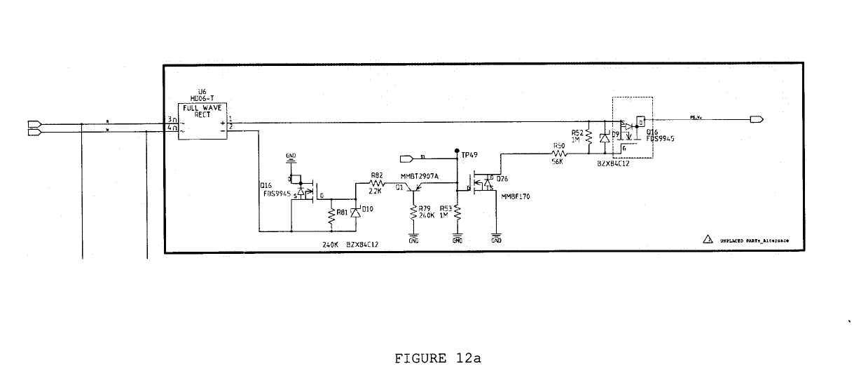

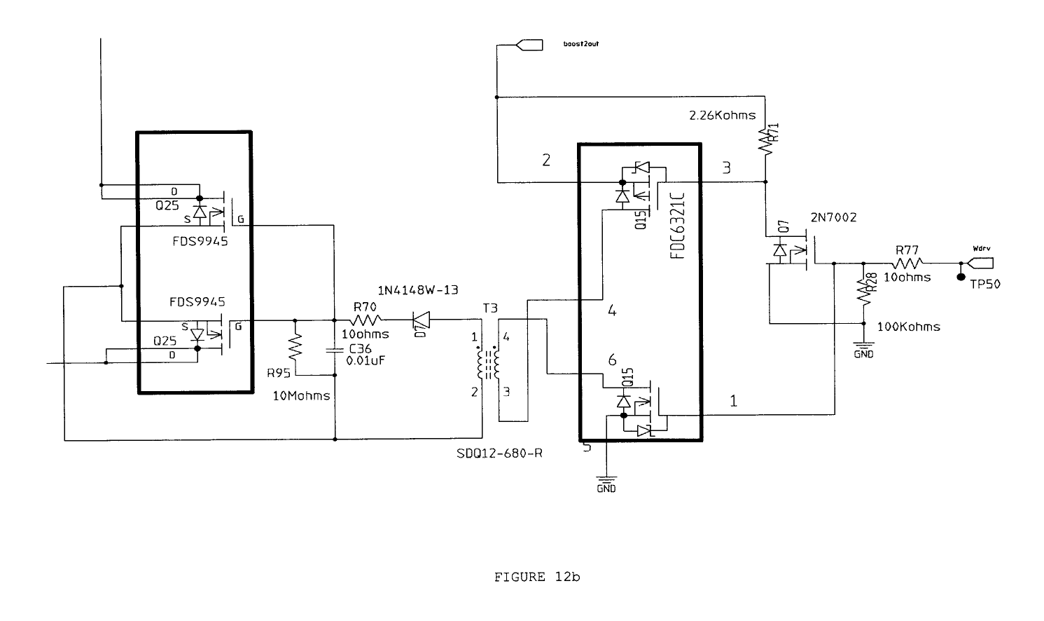

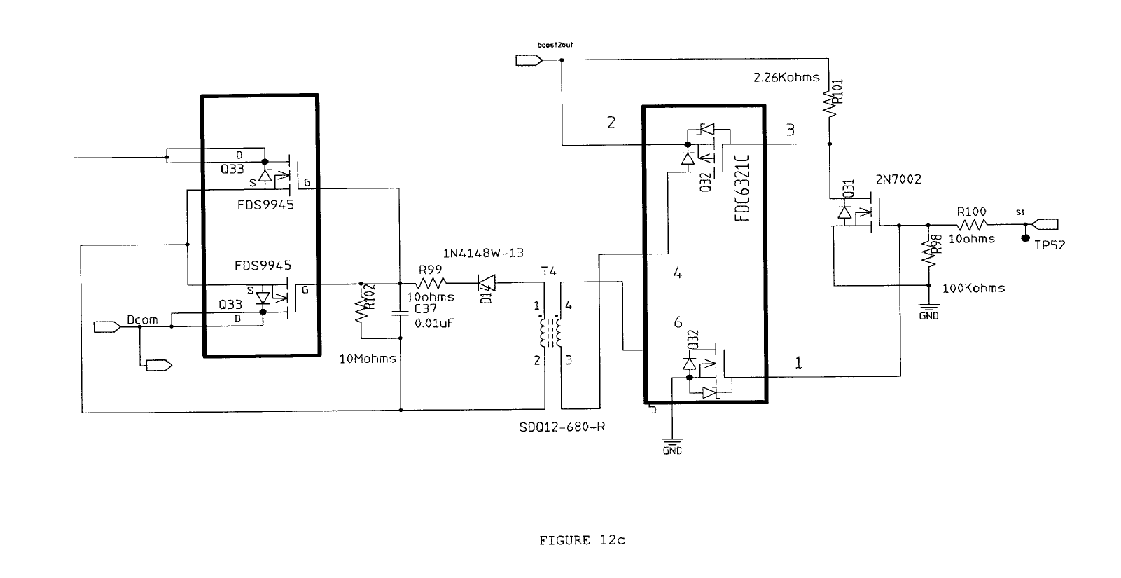

FIGS. 8a, 8b, 9a-9c, 10a-10c, 11a-11c and 12a-12c are schematics of an illustrative example of the present power transformation circuit. The schematics may be useful for constructing an example of the circuit.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A method for power transformation comprising:
providing a programmable AC switch having a first input terminal for connection to a first terminal of a power source, second input terminal for connection to a first terminal of a first load, and having first and second output terminals;
connecting an input of a first current source to the first output terminal of the programmable AC switch;
connecting an output of the first current source to the second output terminal of the programmable AC switch;
connecting an input of a second current source to the first output terminal of the programmable AC switch;
connecting an output of the second current source to a first terminal of an ultra capacitor; and
connecting a second terminal of the ultra capacitor to the second output terminal of the programmable AC switch; and
wherein:
the first load has a second terminal for connection to a second terminal of the power source;
the first current source has a control terminal;
an amount of current through the first current source is adjustable from zero to 100 percent of current available to the first current source from the programmable AC switch, according to a signal to the control terminal; and
an amount of current available for the second current source is the current available to the first current source minus the amount of current to the first current source; and
current from the second current source goes to the ultra capacitor and/or a mechanism connected in parallel with the ultra capacitor.

2. The method of claim 1, wherein the ultra capacitor has a capacitance ranging from one-half farad to 200 farads.

3. The method of claim 1, further comprising adjusting a current from the second current source to the ultra capacitor according to a range selection by a signal to a control terminal of the second current source.

4. The method of claim 3, wherein:
the signal to the control terminal of the first current source is provided by a controller; and
the signal to a control terminal of the second current source is provided by the controller.

5. The method of claim 1, further comprising adding current from a battery to the ultra capacitor and/or the mechanism.

6. The method of claim 1, further comprising:
adding current from a from first and second output terminals of a buck converter to the mechanism; and
wherein:
the buck converter has first and second input terminals connected to first and second output terminals, respectively, of a second programmable AC switch; and
the second programmable AC switch has first and second terminals for connection to the first and second terminals, respectively, of the power source.

7. The method of claim 1, further comprising:
disconnecting and connecting the first load directly and indirectly across the power source with a switch arrangement; and
wherein the switch arrangement comprises a first switch connected between the first terminal of the first load and the first terminal of the power source, and a second switch connected between the first terminal of the first load and the second input terminal of the programmable AC switch.

8. The method of claim 7, further comprising:
connecting a first terminal of a second load to the second input terminal of the programmable AC switch and a second terminal to a second terminal of the power source;
disconnecting and connecting the second load directly and indirectly across the first and second terminals of the power source with a second switch arrangement; and
wherein:
the second switch arrangement comprises a third switch connected between the first terminal of the second load to the first terminal of the power source and a fourth switch connected between the first terminal of the second load and the second input of the programmable AC switch;
the fourth switch is closed and the third switch is opened;
the second switch is closed and the first switch is opened; and
current is available to the programmable AC switch via the first and second loads.

9. The method of claim 1, further comprising:
connecting a current measuring device at the output of the first current source;
connecting a voltage measuring device across the first and second output terminals of the programmable AC switch;
calculating an impedance of the first load from measurements from the current and voltage measuring devices; and
adding or removing a capacitance across the first and second output terminals of the programmable AC switch and/or adjusting current flow through the first current source according to the impedance.

10. A power transformation circuit comprising:
a rectifier having a first input for connection to a first terminal of a power supply, a second input for connection to a first terminal of a first load, a first output, and a second output connected to a reference terminal;
a first current source having an input connected to the first output of the rectifier and having an output connected to the reference terminal;
a second current source having an input connected to the first output of the rectifier; and
an ultra capacitor having a first terminal connected to an output of the second current source and a second terminal connected to the reference terminal; and
wherein:
the first load has a second terminal for connection to a second terminal of the power supply; and
the first and second terminals of the ultra capacitor are for providing current to a device.

11. The circuit of claim 10, wherein the first current source has a control terminal for a signal to adjust an amount of current flowing from the input to the output of the first current source.

12. The circuit of claim 11, wherein the first current source can conduct virtually all of the current available from the rectifier, thereby resulting in a lack of current to the second current source for charging the ultra capacitor.

13. The circuit of claim 11, wherein the current flow of the first current source is adjustable from virtually zero percent to 100 percent of the current available to the first current source, according to a signal to the control terminal of the first current source.

14. The circuit of claim 13, wherein the amount of current available to the second current source is virtually all of the current available to the first current source minus the current flowing through the first current source.

15. The circuit of claim 14, wherein:
at least a portion of the current provided to the second current source is stored as a charge at the capacitor; and
virtually any remaining portion of the current provided to the second current source can be provided to the device having a first terminal for connection to the first terminal of the capacitor and a second terminal for connection to the second terminal of the capacitor.

16. The circuit of claim 10, further comprising:
a first switch for connection or disconnection of a connection between the first terminal of the first load and the second input of the rectifier; and
a second switch for connection or disconnection of a connection between the first terminal of the load and the first terminal of the power supply; and
wherein:
if the second switch is on, then the first switch should be on before the second switch is turned off; and
if the first switch is on, then the second switch should be on before the first switch is turned off.

17. A power transformation system comprising:
a rectifier having a first input connected to a first terminal of a power source, a second input connected to a first terminal of a load, a first output, and a second output connected to a reference terminal;
a first current source having a first terminal connected to the first output of the rectifier, and a second terminal connected to the reference terminal;
a second current source having a first terminal connected to the first output of the rectifier, and a second terminal; and
an ultra capacitor having a first terminal connected to the second terminal of the second current source, and a second terminal connected to the reference terminal; and
wherein a second terminal of the load is connected to a second terminal of the power source.

18. The system of claim 17, wherein the first current source comprises:
a first state of conduction; and
a second state of conduction; and
wherein:
the first state of conduction of the first current source is when the first current source conducts virtually all of the current available to the first current source;
the second state of conduction is when the first current source conducts a first portion of virtually all of the current available to the first current source; and
a second portion of virtually all of the current available to the first current source is conducted by the second current source to the ultra capacitor and/or a device.

19. The system of claim 17, further comprising:
a switch connected between the first output of the rectifier and the first terminal of the second current source; and
wherein:
the second current source provides current to the ultra capacitor; and
when the ultra capacitor is charged to a predetermined value, a controller receives a value indication from the first terminal of the ultra capacitor, and provides a signal to the switch to disconnect the first terminal of the second current source from the first output of the rectifier.

20. The system of claim 18, further comprising:
a first switch connecting the first terminal of the load to the first terminal of the power source; and
wherein when the first switch is turned on to establish a connection between the first terminal of the load and the first terminal of the power source, current is routed away from the rectifier and consequently reduces the current available to the first current source.

21. The system of claim 20, further comprising:
a second switch connected between first terminal of the load and the second input terminal of the rectifier; and
wherein:
the first switch is turned on before the second switch is turned off;
the second switch is turned on before the first switch is turned off; and
the current available to the first current source is increased.
